(19) United States
(12) Patent Application Publication
(10) Pub. No.: US 2025/0165958 A1
(43) Pub. Date: May 22, 2025

(54) Digital Custody Transactions

(71) Applicant: Vaultavo, Inc., New York, NY (US)

(72) Inventor: Keith Derrick Kourie, Johannesburg (ZA)

(21) Appl. No.: 19/032,457

(22) Filed: Jan. 21, 2025

Related U.S. Application Data
(63) Continuation of application No. PCT/IB2023/059344, filed on Sep. 21, 2023.
(60) Provisional application No. 63/409,378, filed on Sep. 23, 2022.

(51) Int. Cl. G06Q 20/36

(52) U.S. Cl. CPC G06Q 20/3674; G06Q 20/3678

(57) ABSTRACT

Systems and methods associated with initiating an asset send transaction in a blockchain custody system are disclosed. In one example implementation, an illustrative method may include receiving an encrypted initiate send transaction message from a remote initiator, the remote initiator being the holder of a biometrically enabled security device, receiving an encrypted authorize/verify send transaction message from a remote authorizer, executing a sent transaction in accordance with the encrypted initiate send transaction message and completing the send transaction on the blockchain custody system.

### CROSS-REFERENCE TO RELATED APPLICATIONS INFORMATION

This application is a continuation of PCT International application No. PCT/IB2023/059344, Int'l filing date 21 Sep. 2023, published as WO2024/062411A2, and which claims benefit/priority of U.S. provisional application No. 63/409,378, filed 23 Sep. 2022, all of which are incorporated herein by reference in entirety.

### BACKGROUND

### Field

The disclosed technology relates to digital custody transactions. In particular, aspects of the innovations herein relate to systems and methods involving initiating an asset send transaction.

### Description of Related Information

Modern digital transaction systems rely on blockchain technology to facilitate digital transactions. This technology is used increasingly in real world transactions to ensure independently verified secure transactions. Use of blockchain technology leads to the need for curation of blockchain assets by independent third parties.

The most significant growth in blockchain transactions has been in the market of smaller entities, which implies reduced unit value/increased volume transactions.

The adoption of blockchain assets has been in all goods and services markets such as legal firms, accounting firms, luxury goods market, exclusive art and the like.

However, as any blockchain asset is singular, the custody thereof is of critical importance and a combination of software and hardware custody systems are often preferred. The inventor therefore identified a need to provide a method to facilitate a blockchain transaction on a combination hardware/software custody system that is safe and secure, not vulnerable to attacks from hackers, only accessible by authorized parties and which provides adequate backup in event of failure.

It is to be appreciated that this specification is for a method of initiating an asset send transaction. However, to assist in the understanding of the specification, definitions are provided for the software/hardware on which the method is implemented. Generic terms used in the field of blockchain technology will not be explained as it is assumed that the addressee of the patent is a person skilled in the art of blockchain technology. Such generic terms should be given their ordinary meaning in this relevant field of technology.

A blockchain custody system is a software/hardwaresystem on which Blockchain transactions can be stored and accessed. Known access control methods are implemented to ensure blockchain transactions are only accessible by authorized users of the blockchain custody system.

The blockchain custody system includes a system on which is stored any one or more of:
a plurality of organizations being listed for operation and access by authorized users;
each organization has stored under it a number of accounts being listed for operation and access by authorized users;
each account has stored under it a number of wallets being listed for operation and access by authorized users;
each wallet has stored under it a number of assets being listed for operation and access by authorized users; and
each asset has stored under it a plurality of private and public keys/addresses representing a balance stored on a blockchain.

Users are defined as any one of:
a remote initiator;
a remote authorizer;
an asset owner is a person or entity which owns the asset of which the balance is stored on the blockchain.

Policy rules are predefined rules or criteria that each type of transaction have to conform to.

A biometrically enabled security device is a device comprising:
a biometric reader operable to generate a seed of a secure random number in the form of an asymmetric cryptographic key pair known as Public/Private keys, the seed being generated from a biometric feature vector of a person; and
a security controller operable to generate at least one secure random number from the seed generated by the biometric reader.

### Overview of Some Aspects

According to one aspect of the disclosed technology, in a blockchain custody system, there is provided a method of initiating an asset send transaction, which may include one or more of
receiving an encrypted initiate send transaction message from a remote initiator, the remote initiator being the holder of a biometrically enabled security device;
receiving an encrypted authorize/verify send transaction message from a remote authorizer;
executing a sent transaction in accordance with the encrypted initiate send transaction message; and/or
completing the send transaction on the blockchain custody system.

The method may include prior to receiving an encrypted initiate send transaction message from a remote initiator the step, by a remote initiator, of initiating the asset send transaction.

The step of initiating the asset send transaction by a remote initiator may include the following sequential steps:
a remote initiator logs into a custody system;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with a balance and any other relevant information of the selected asset;
a remote initiator enters all relevant information required to which the selected asset should be transferred including, such as a destination address and an amount/value; and
a remote initiator confirms/authorizes the asset send transaction.

The step of initiating the asset send transaction may include the step of displaying customizable fields to a remote initiator.

The step of entering a destination address to which the selected asset should be transferred may include any one of:
entering the destination address manually;
scanning the destination address which is presented in the form of a unique visual code, such as a QR code;
selecting the destination address from a pre-populated list of destination addresses.

The step of initiating the asset send transaction may include the additional step of displaying a transaction fee and any other fees after the remote initiator entered an amount of the selected asset that should be transferred.

The step of initiating the asset send transaction may include the additional step of entering custom field values.

The method may include, prior to receiving an encrypted authorize/verify send transaction message from a remote authorizer the step, by at least one remote authorizer, of authorizing the asset send transaction.

The step of authorizing the asset send transaction may include the following sequential steps:
a remote authorizer logs into a custody system;
a remote authorizer selects an organization from a list of organizations to which the remote authorizer has access;
a remote authorizer selects a pending send transaction from a list of pending send transactions;
a remote authorizer views details of the selected pending send transaction;
a remote authorizer then confirms/authorizes the send transaction.

The step of authorizing the asset send transaction may include the additional step of displaying custom field values to the remote authorizer. The step of authorizing the asset send transaction may then also include the step of entering custom field values.

The step of executing a sent transaction in accordance with the encrypted initiate send transaction message may include the following sequential steps:
the blockchain custody system receives the encrypted initiate send transaction;
the blockchain custody system receives the encrypted authorize verify send transaction messages;
the blockchain custody system checks the send transaction against policy rules and predefined values;
the blockchain custody system then sends the encrypted messages to an asset owner's biometrically enabled security device (being hosted on a security module in the blockchain custody system);
the blockchain custody system receives the signed blockchain transaction from the asset owner's biometrically enabled security device;
the blockchain custody system sends the signed blockchain transaction to remote processors to be mined.

The step of executing a send transaction may include the intermediary steps, between the sending of the encrypted messages to the initiator's biometrically enabled security device and the receiving of the signed blockchain transaction from the asset owner's biometrically enabled security device, of
the owner's biometrically enabled security device authenticates and validates the initiator's encrypted message and other encrypted messages and checks the send transaction against policy rules and predefined values; and
the owner's biometrically enabled security device signing the blockchain transaction using the encrypted messages.

The step of completing the send transaction on the blockchain custody system in the method of initiating an asset send transaction may include the following sequential steps:
monitoring the blockchain transaction being sent for mining until the required threshold number of transaction confirmations have been met;
marking the send transaction as complete once the required number of transaction confirmations has been met.

The disclosed technology will now be described, by way of example only, with reference to the following figures.

### BRIEF DESCRIPTION OF THE FIGURES

In the figures:

FIG. 1 shows a high-level schematic flow diagram of an exemplary method of initiating an illustrative asset send transaction, according to one or more aspects of the disclosed technology;

FIG. 2 shows a more detailed schematic flow diagram of the exemplary method of initiating an illustrative asset send transaction consistent with FIG. 1, according to one or more aspects of the disclosed technology;

FIG. 3 shows exemplary steps of initiating an illustrative asset send transaction via a remote initiator consistent with the method of FIG. 2, according to one or more aspects of the disclosed technology;

FIG. 4 shows exemplary steps of authorizing an illustrative asset send transaction consistent with the method of FIG. 2, according to one or more aspects of the disclosed technology;

FIG. 5 shows exemplary steps of executing an illustrative sent transaction consistent with the method of FIG. 2, according to one or more aspects of the disclosed technology; and

FIG. 6 shows exemplary steps of completing an illustrative send transaction consistent with the method of FIG. 2, according to one or more aspects of the disclosed technology.

In the figures, like reference numerals denote like parts of the invention unless otherwise indicated.

### DETAILED DESCRIPTION OF ILLUSTRATIVE IMPLEMENTATIONS

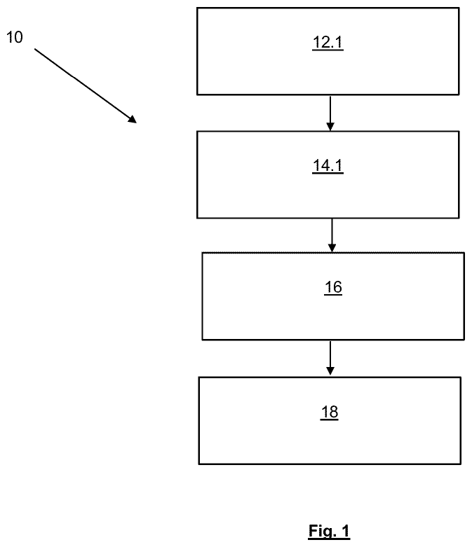

In FIG. 1 a schematic flow diagram of a method of initiating an asset send transaction (10) is shown.

In the method of initiating an asset send transaction (10), which is implemented in a blockchain custody system, the method is initiated by receiving an encrypted initiate send transaction message at (12.1) from a remote initiator, the remote initiator being the holder of a biometrically enabled security device.

The method then receives an encrypted authorize/verify send transaction message from at least one remote authorizer at (14.1), then executes a sent transaction in accordance with the encrypted initiate send transaction message at (16), and terminates by completing the send transaction on the blockchain custody system at (18).

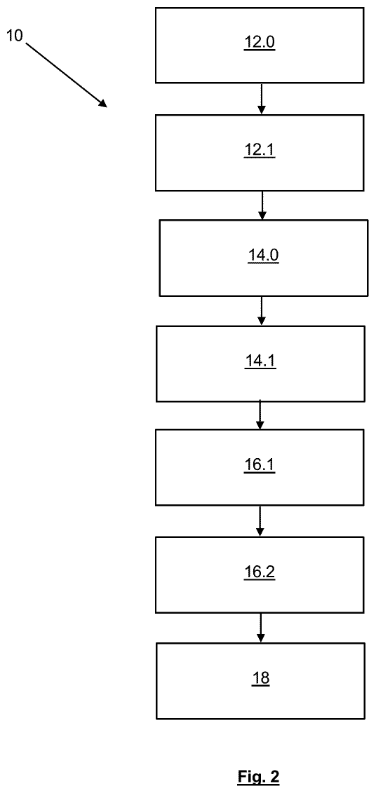

In FIG. 2 illustrates a more detailed flow diagram of the method of initiating an asset send transaction, as shown in FIG. 1.

The method that initiates at (12.1) with receiving an encrypted initiate send transaction message includes the step of initiating the asset send transaction at (12.0). The method may include, prior to receiving an encrypted authorize/verify send transaction message from the at least one remote authorizer at (14.1) the step, by at least one remote authorizer, of authorizing the asset send transaction at (14.0).

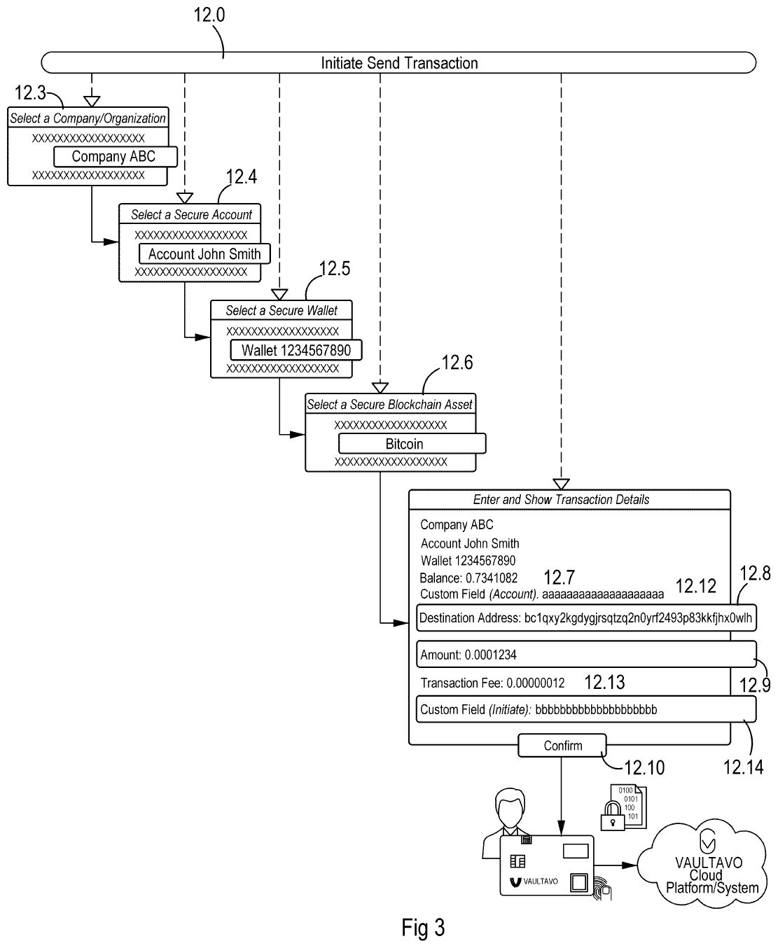

The step of initiating the asset send transaction (12.0) by a remote initiator includes the following sequential steps, that are shown in FIG. 3:
At (12.2) a remote initiator logs into a custody system;
At (12.3) the remote initiator selects an organization from a list of organizations to which the remote initiator has access;
At (12.4) the remote initiator selects an account from a list of accounts to which the remote initiator has access of the selected organization;
At (12.5) the remote initiator selects a wallet from a list of wallets to which the remote initiator has access of the selected accounts to which the remote initiator has access;
At (12.6) the remote initiator selects an asset from a list of assets to which the remote initiator has access of the selected wallets to which the remote initiator has access;
At (12.7) the remote initiator is presented with a balance and any other relevant information of the selected asset;
At (12.8) and (12.9) the remote initiator enters all relevant information required to which the selected asset should be transferred such as a destination address and an amount/value a destination address to which the selected asset should be transferred; and
At (12.10) the remote initiator confirms/authorizes the asset send transaction.
As can be seen, at (12.12), the step of initiating the asset send transaction includes displaying customizable fields to a remote initiator.
The step (12.8) of entering a destination address to which the selected asset should be transferred can include any one of: entering the destination address manually, scanning the destination address which is presented in the form of a unique visual code, such as a QR code, selecting the destination address from a pre-populated list of destination addresses.
As can be seen there is provided for the additional step at (12.13) of displaying a transaction fee and any other fees after the remote initiator entered an amount of the selected asset that should be transferred.
Furthermore, at (12.14) there is provided the additional step of entering custom field values.

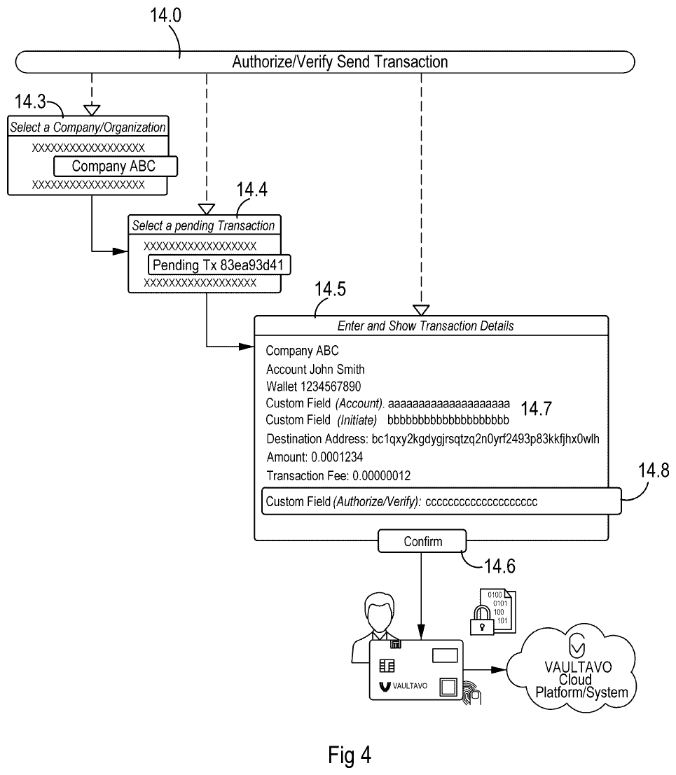

The step of authorizing the asset send transaction (14.0) includes the following sequential steps, that are shown in FIG. 4:
At (14.2) a remote authorizer logs into a custody system;
At (14,3) a remote authorizer selects an organization from a list of organizations to which the remote authorizer has access;
At (14,4) a remote authorizer selects a pending send transaction from a list of pending send transactions;
At (14.5) a remote authorizer view details of the selected pending send transaction;
At (14.6) a remote authorizer then confirms/authorizes the send transaction.
At (14.7), the step of authorizing the asset send transaction includes the additional step of displaying custom field values to the remote authorizer. At (14.8) the step of authorizing the asset send transaction then also includes the step of entering custom field values.

It is to be appreciated, if multiple authorizers are to authorize a transaction, step (14.0) may be repeated multiple times.

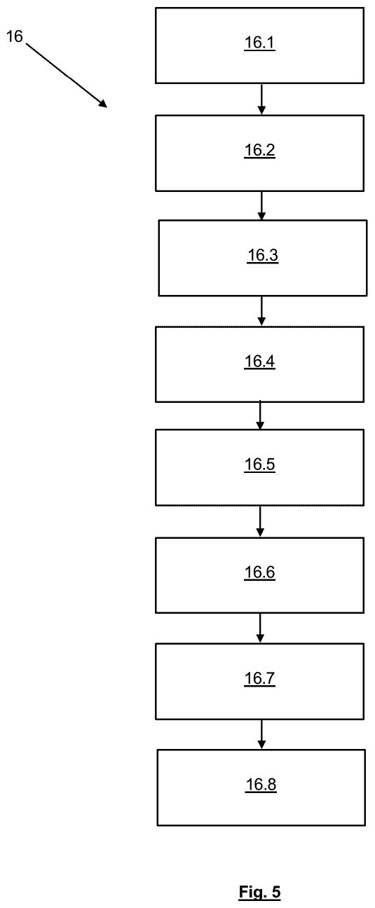

FIG. 5 shows the step of executing a sent transaction (16) in accordance with the method (10) in more detail.

The step of executing a sent transaction (16) in accordance with the encrypted send transaction message includes the following sequential steps:
At (16.1) the blockchain custody system receives the encrypted initiate send transaction;
At (16.2) the blockchain custody system receives the encrypted authorize verify send transaction messages;
At (16.3) the blockchain custody system checks the send transaction against policy rules and predefined values;
At (16.4) the blockchain custody system then sends the encrypted messages to the asset owner's biometrically enabled security device (being hosted on a security module in the blockchain custody system);
At (16.5) the asset owner's biometrically enabled security device authenticates and validates the initiator's encrypted message and other encrypted messages and checks the send transaction against policy rules and predefined values;
At (16.6) the asset owner's biometrically enabled security device signs the blockchain transaction using the encrypted messages;
At (16.7) the blockchain custody system receives the signed blockchain transaction from the asset owner's biometrically enabled security device;
At (16.8) the blockchain custody system sends the signed blockchain transaction to remote processors to be mined.

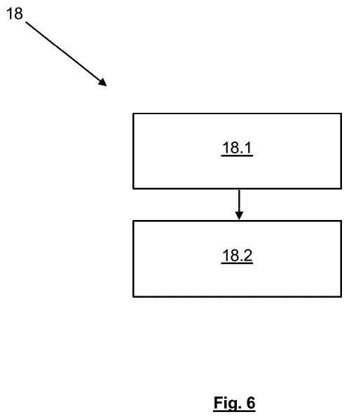

As shown in FIG. 6, the step of completing the send transaction (18) on the blockchain custody system in the method (10) of initiating an asset send transaction includes the following sequential steps:
At (18.1) the blockchain transaction being sent for mining is monitored until the required threshold number of transaction confirmations have been met;
At (18.2) the send transaction is marked as complete once the required number of transaction confirmations has been met.
Consistent with the innovations set forth herein, the disclosed technology provides novel systems and methods of initiating an asset send transaction, which are, e.g., of particular use in a method to facilitate a blockchain transaction on a combination hardware/software custody system that is safe and secure, not vulnerable to attacks from hackers, only accessible by authorized parties and which provides adequate backup in event of failure.

1. A method of initiating an asset send transaction in a blockchain custody system, which method includes
receiving an encrypted initiate send transaction message from a remote initiator, the remote initiator being the holder of a biometrically enabled security device;
receiving an encrypted authorize/verify send transaction message from a remote authorizer;
executing a sent transaction in accordance with the encrypted initiate send transaction message; and
completing the send transaction on the blockchain custody system.

2. The method of claim 1 or the invention of any claim herein, which includes prior to receiving an encrypted initiate send transaction message from a remote initiator the step, by a remote initiator, of initiating the asset send transaction.

3. The method of claim 2 or the invention of any claim herein, in which the step of initiating the asset send transaction by a remote initiator includes one or more of the following steps:
a remote initiator logs into a custody system;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with a balance and any other relevant information of the selected asset;
a remote initiator enters the relevant information required to which the selected asset should be transferred including, a destination address and an amount/value; and
a remote initiator confirms/authorizes the asset send transaction.

4. The method of claim 3 or the invention of any claim herein, in which the step of initiating the asset send transaction includes the step of displaying customizable fields to a remote initiator.

5. The method of claim 3 or the invention of any claim herein, in which the step of entering a destination address to which the selected asset should be transferred includes any one of:
entering the destination address manually;
scanning the destination address which is presented in the form of a unique visual code, such as a QR code;
selecting the destination address from a pre-populated list of destination addresses.

6. The method of claim 2 or the invention of any claim herein, in which the step of initiating the asset send transaction includes the additional step of displaying a transaction fee and any other fees after the remote initiator entered an amount of the selected asset that should be transferred.

7. The method of claim 2 or the invention of any claim herein, in which the step of initiating the asset send transaction includes the additional step of entering custom field values.

8. The method of claim 1 or the invention of any claim herein, which includes, prior to receiving an encrypted authorize/verify send transaction message from a remote authorizer the step, by at least one remote authorizer, of authorizing the asset send transaction.

9. The method of claim 8 or the invention of any claim herein, in which the step of authorizing the asset send transaction includes one or more of the following steps:
a remote authorizer logs into a custody system;
a remote authorizer selects an organization from a list of organizations to which the remote authorizer has access;
a remote authorizer selects a pending send transaction from a list of pending send transactions;
a remote authorizer views details of the selected pending send transaction; and
a remote authorizer then confirms/authorizes the send transaction.

10. The method of claim 9 or the invention of any claim herein, in which the step of authorizing the asset send transaction includes the additional step of displaying custom field values to the remote authorizer.

11. The method of claim 9 or the invention of any claim herein, in which the step of authorizing the asset send transaction includes the step of entering custom field values.

12. The method of claim 1 or the invention of any claim herein, in which the step of executing a sent transaction in accordance with the encrypted initiate send transaction message includes one or more of the following steps:
the blockchain custody system receives the encrypted initiate send transaction;
the blockchain custody system receives the encrypted authorize verify send transaction messages;
the blockchain custody system checks the send transaction against policy rules and predefined values;
the blockchain custody system then sends the encrypted messages to an asset owner's biometrically enabled security device (being hosted on a security module in the blockchain custody system);
the blockchain custody system receives the signed blockchain transaction from the asset owner's biometrically enabled security device; and
the blockchain custody system sends the signed blockchain transaction to remote processors to be mined.

13. The method of claim 12 or the invention of any claim herein, in which the step of executing a send transaction includes the intermediary steps, between the sending of the encrypted messages to the initiator's biometrically enabled security device and the receiving of the signed blockchain transaction from the asset owner's biometrically enabled security device, of
the owner's biometrically enabled security device authenticates and validates the initiator's encrypted message and other encrypted messages and checks the send transaction against policy rules and predefined values; and
the owner's biometrically enabled security device signing the blockchain transaction using the encrypted messages.

14. The method of claim 1 or the invention of any claim herein, in which the step of completing the send transaction on the blockchain custody system in the method of initiating an asset send transaction includes the following sequential steps:
monitoring the blockchain transaction being sent for mining until the required threshold number of transaction confirmations have been met; and
marking the send transaction as complete once the required number of transaction confirmations has been met.

15. A method as claimed in claim 1, substantially as herein described and illustrated.

16. A system comprising:
at least one processor; and
one or more non-transitory computer readable media in operative communication with the at least one processor, the non-transitory computer readable media having stored thereon computer readable instructions that, upon execution by the at least one processor, cause the at least one processor to execution operations associated with a method of processing an asset send transaction in a blockchain custody system, the method comprising:
receiving an encrypted initiate send transaction message from a remote initiator, the remote initiator being the holder of a biometrically enabled security device;
receiving an encrypted authorize/verify send transaction message from a remote authorizer;
executing a sent transaction in accordance with the encrypted initiate send transaction message; and
completing the send transaction on the blockchain custody system.

17. The system of claim 16, which includes prior to receiving an encrypted initiate send transaction message from a remote initiator the step, by a remote initiator, of initiating the asset send transaction.

18. The system of claim 17 or the invention of any claim herein, in which the step of initiating the asset send transaction by a remote initiator includes one or more of the following steps:
a remote initiator logs into a custody system;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with a balance and any other relevant information of the selected asset;
a remote initiator enters the relevant information required to which the selected asset should be transferred including, a destination address and an amount/value; and
a remote initiator confirms/authorizes the asset send transaction.

19. The system of claim 18 or the invention of any claim herein, in which the step of initiating the asset send transaction includes the step of displaying customizable fields to a remote initiator.

20. The system of claim 18 or the invention of any claim herein, in which the step of entering a destination address to which the selected asset should be transferred includes any one of:
entering the destination address manually;
scanning the destination address which is presented in the form of a unique visual code, such as a QR code;
selecting the destination address from a pre-populated list of destination addresses.

21. The system of claim 17 or the invention of any claim herein, in which the step of initiating the asset send transaction includes the additional step of displaying a transaction fee and any other fees after the remote initiator entered an amount of the selected asset that should be transferred.

22. The system of claim 17 or the invention of any claim herein, in which the step of initiating the asset send transaction includes the additional step of entering custom field values.

23. The system of claim 16 or the invention of any claim herein, which includes, prior to receiving an encrypted authorize/verify send transaction message from a remote authorizer the step, by at least one remote authorizer, of authorizing the asset send transaction.

24. The system of claim 23 or the invention of any claim herein, in which the step of authorizing the asset send transaction includes one or more of the following steps:
a remote authorizer logs into a custody system;
a remote authorizer selects an organization from a list of organizations to which the remote authorizer has access;
a remote authorizer selects a pending send transaction from a list of pending send transactions;
a remote authorizer views details of the selected pending send transaction; and
a remote authorizer then confirms/authorizes the send transaction.

25. The system of claim 24 or the invention of any claim herein, in which the step of authorizing the asset send transaction includes the additional step of displaying custom field values to the remote authorizer.

26. The system of claim 24 or the invention of any claim herein, in which the step of authorizing the asset send transaction includes the step of entering custom field values.

27. The system of claim 16 or the invention of any claim herein, in which the step of executing a sent transaction in accordance with the encrypted initiate send transaction message includes one or more of the following steps:
the blockchain custody system receives the encrypted initiate send transaction;
the blockchain custody system receives the encrypted authorize verify send transaction messages;
the blockchain custody system checks the send transaction against policy rules and predefined values;
the blockchain custody system then sends the encrypted messages to an asset owner's biometrically enabled security device (being hosted on a security module in the blockchain custody system);
the blockchain custody system receives the signed blockchain transaction from the asset owner's biometrically enabled security device; and
the blockchain custody system sends the signed blockchain transaction to remote processors to be mined.

28. The system of claim 27 or the invention of any claim herein, in which the step of executing a send transaction includes the intermediary steps, between the sending of the encrypted messages to the initiator's biometrically enabled security device and the receiving of the signed blockchain transaction from the asset owner's biometrically enabled security device, of
the owner's biometrically enabled security device authenticates and validates the initiator's encrypted message and other encrypted messages and checks the send transaction against policy rules and predefined values; and
the owner's biometrically enabled security device signing the blockchain transaction using the encrypted messages.

29. The system of claim 16 or the invention of any claim herein, in which the step of completing the send transaction on the blockchain custody system in the method of initiating an asset send transaction includes the following sequential steps:
monitoring the blockchain transaction being sent for mining until the required threshold number of transaction confirmations have been met; and
marking the send transaction as complete once the required number of transaction confirmations has been met.

30. One or more non-transitory computer readable media having stored thereon computer readable instructions that, upon execution by at least one processor, cause the at least one processor to:
perform one or more portions, aspects and/or steps of any of claims 1-29 and/or other features or functionality set forth elsewhere in this disclosure.
